(19) United States
(12) Patent Application Publication
(10) Pub. No.: US 2005/0242712 A1
(43) Pub. Date: Nov. 3, 2005

(54) Multicolor electroluminescent display

(76) Inventor: Chao-Chin Sung, Pingtung City (TW)

Correspondence Address: David I. Roche;BAKER & McKENZIE, 130 E. Randolph Drive, Chicago, IL, 60601, US

(21) Appl. No.: 10/834,530

(22) Filed: Apr. 29, 2004

(51) Int. Cl. H05B 33/00

(52) U.S. Cl. 313/503; 313/506

(57) ABSTRACT

In an organic electroluminescent display, a pixel includes a plurality of color light-emitting units that are arranged in multi-layer stacks of specific color emissions. The color light-emitting units include layers made of organic electroluminescent materials. The stacks of different color emissions include different numbers of color light-emitting units to compensate the degradation of specific color emissions.

### BACKGROUND OF THE INVENTION

1. Field of the Invention

This invention relates to multicolor electroluminescent displays, and more particularly to the pixel structure of a multicolor electroluminescent display that can compensate the degradation of specific color emissions in the pixel.

2. Description of the Related Art

Electroluminescent display technology has recently attracted many researches and developments in the field of emissive displays. Compared to other types of emissive displays such as the plasma display, the electroluminescent display promises advantages such as a lower power consumption, a reduced size, and high image brightness and sharpness. An electroluminescent display system conventionally includes a mesh of scan and data lines that define an array of pixels in each of which is coupled one light-emitting device. The light-emitting device particularly can be an organic light-emitting device (OLED), and is usually driven by a driving circuit associated to each pixel.

Conventionally, a basic OLED cell is constructed from a stack of layers made of organic material and sandwiched between two electrode layers, i.e. one anode and one cathode. The organic layers usually include a hole transport layer, an emissive layer, and an electron transport layer. When an adequate voltage is applied between the anode and the cathode, the injected positive and negative charges recombine in the emissive layer to produce light.

The particular color emitted by one OLED cell depends on the type of organic material incorporated therein. In a multicolor electroluminescent display, the pixel structure therefore is generally configured to include a plurality of OLED of different basic color emissions. In operation, these color lights are mixed to provide a full spectrum of display colors.

FIG. 1A is a schematic view of the conventional pixel structure implemented in a multicolor electroluminescent display known in the art. The pixel 100 is conventionally divided into at least three color subpixels 110, 120, 130, each of which includes an OLED formed on a transparent substrate 102 and configured to irradiate red (R), green (G), and blue light (B), respectively. In each color subpixel 110, 120, 130, the OLED can be constructed from the stack of a light-emitting unit 114, 124, 134 and a charge generation layer 108 between top and bottom electrode layers 104, 106.

One major technical issue encountered in the conventional electroluminescent display is its reliability. After a time of service, the screen of the electroluminescent display usually becomes nonuniform due to the difference in the aging rate of each color light-emitting unit. The difference of aging rate is due to a characteristic alteration that varies between different electroluminescent materials. Experimentally, it can be observed that red OLED has a service life of about 10,000 hours, green OLED about 3,000 hours, and blue OLED about 1,000 hours at experiment brightness.

The graph of FIG. 1B depicts this difference in the aging rate of the red, green and blue OLED. It can be observed that the decay of blue color is very fast, while green and red color degrade relatively slower. Consequently, the white color balance of the electroluminescent displaye is significantly biased after a period of time due to the specific color brightness degradation. This disadvantage usually results in a short service life of the organic electroluminescent display.

Some technical approaches have been made to remedy this reliability issue. One of the solution known in the art proposes the addition of a feedback control circuit to adjust the electric current flowing through the OLED, and thereby compensate the intrinsic property degradation of the light-emitting unit. However, this approach provide limited results, and still fail to prolong the service life of the organic electroluminescent display.

Therefore, there is presently a need for an electroluminescent display that can overcome the above disadvantages, does not experiences color bias, and have a longer service life.

### SUMMARY OF THE INVENTION

The invention provides a pixel structure for a multicolor electroluminescent display which can mitigate the degradation of specific color emissions. In one embodiment, the multicolor electroluminescent display comprises a plurality of color light-emitting units, including electroluminescent materials configured to irradiate color lights, which are arranged in multi-layer stacks of specific color emissions in one pixel area. In this arrangement, at least two stacks of two specific colors have different sizes to compensate a difference in the degradation of color emission in the two stacks. In one embodiment, the two stacks of different color emissions include different numbers of color light-emitting units. In another embodiment, the two stacks of different color emissions occupy different surface areas on the transparent substrate.

The foregoing is a summary and shall not be construed to limit the scope of the claims. The operations and structures disclosed herein may be implemented in a number of ways, and such changes and modifications may be made without departing from this invention and its broader aspects. Other aspects, inventive features, and advantages of the invention, as defined solely by the claims, are described in the non-limiting detailed description set forth below.

### BRIEF DESCRIPTION OF THE DRAWINGS

FIG. 1A is a schematic view of the conventional pixel structure implemented in a multicolor electroluminescent display known in the art;

FIG. 1B is a graph depicting a nonuniform color brightness degradation observed in a multicolor electroluminescent display known in the art;

FIG. 2A is a schematic view of the pixel structure implemented in a multicolor electroluminescent display according to an embodiment of the invention;

FIG. 2B is a graph depicting a uniform color brightness degradation observed in a multicolor electroluminescent display according to an embodiment of the invention; and

FIGS. 2C and 2D are schematic views of the pixel structure implemented in a multicolor electroluminescent display according to variant embodiments of the invention.

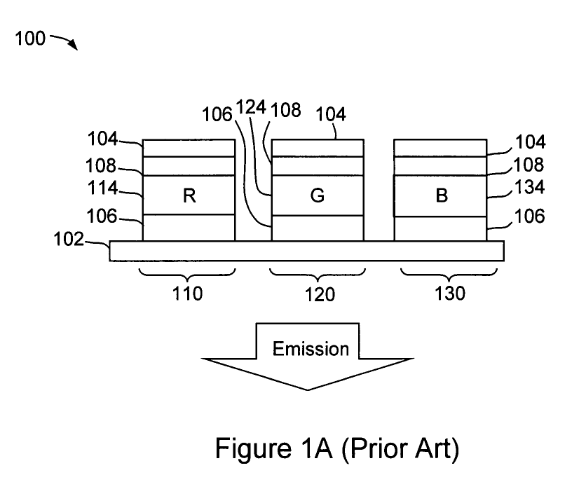

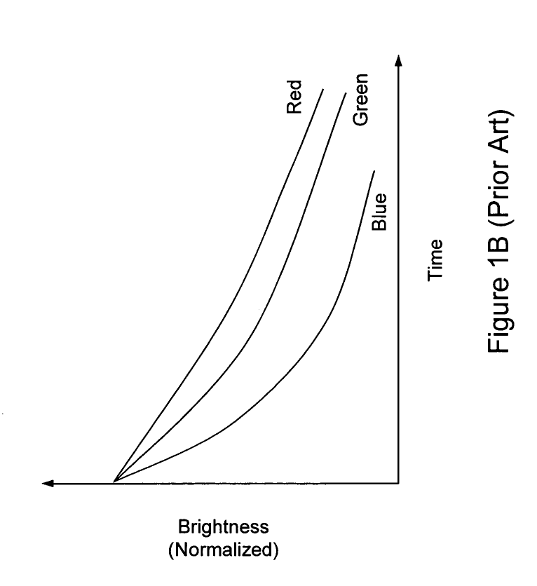

### DETAILED DESCRIPTION OF THE EMBODIMENT(S)

The application describes a multicolor electroluminescent display. The multicolor electroluminescent display includes an array of pixels, each of which is comprised of color subpixels constructed from multi-layer structures including light-emitting units. The size of the multi-layer structure increases as the aging rate of its light-emitting unit is faster so as to compensate the difference in brightness degradation of the color subpixels.

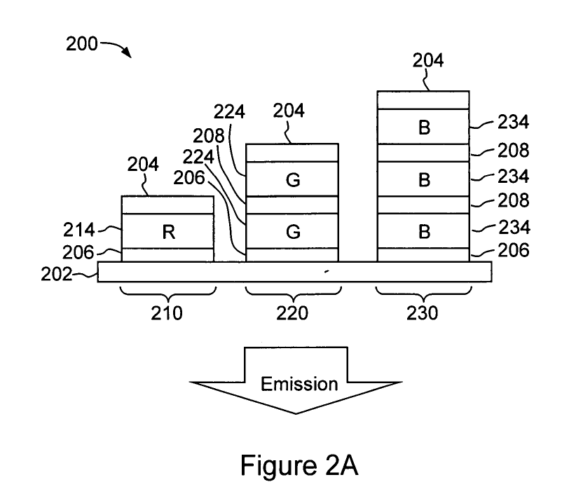

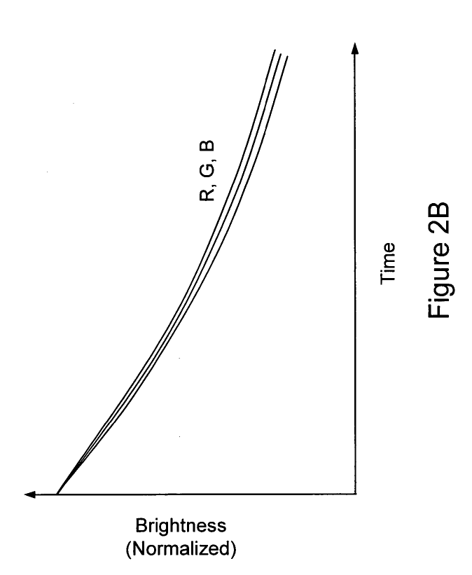

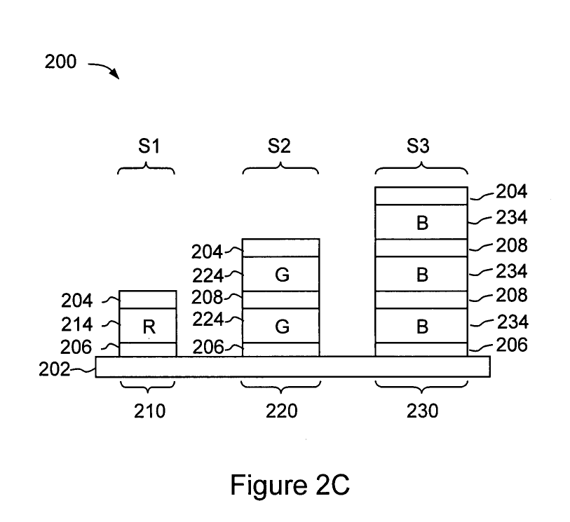

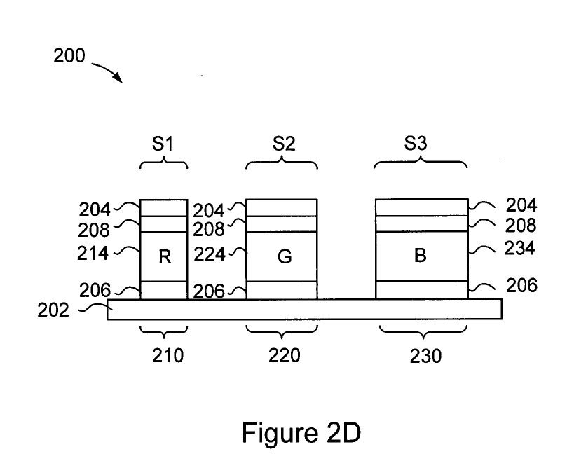

FIG. 2A is a schematic view of the multi-layer structure implemented in a multicolor electroluminescent display according to an embodiment of the invention. FIG. 2A shows the area of approximately one pixel. The pixel 200 includes a plurality of color subpixels 210, 220, 230. The illustrated embodiment exemplary implements a color system comprised of the three basic colors red (R), green (G) and blue (B), which results in at least three sets of color subpixels in each pixel 200, i.e. red, green and blue color subpixels.

Each color subpixel 210, 220, 230 includes a number of light-emitting units 214, 224, 234 stacked on a transparent substrate 202. The transparent substrate 202 can be made of an insulating transparent material such as sapphire, glass, SiC or the like. Each of the light-emitting units 214, 224, 234 can include stacked layers made of organic-based electroluminescent materials such as polymer electroluminescent materials. The number of light-emitting units 214, 224, 234 in each stack varies according to the particular color of the corresponding subpixel. For the purpose of illustration, FIG. 2A exemplary shows an implementation in which the red subpixel 210 includes one red light-emitting unit 214, the green subpixel 220 includes the stack of two green light-emitting units 224, and the blue subpixel 230 includes the stack of three blue light-emitting units 234. In the present embodiment, the faster the aging rate of one particular light-emitting unit, the higher the number of corresponding light-emitting units included in the color subpixel to compensate the brightness degradation.

As shown in FIG. 2A, the red subpixel 210 is formed from a multi-layer stack comprised of a red light-emitting unit 214 sandwiched between two electrode layers 204, 206. In an example of implementation, the red light-emitting unit 214 can be formed of a multi-layer structure including a hole transporting layer made of 4,4′bis[N-1-naphthyl-N-phenyl-amino]biphenyl (α-NPD), a red emissive layer made of 3% of [2-methyl-6-[2-(2,3,6,7-tetrahydro-1H,5H-benzo quinolizin-9-yl)ethenyl]-4H-pyran-4-ylidene]propane-dinitrile (DCM2) doped in tris(8-hydroxyquinoline) aluminum (III) (Alq₃), and an electron transporting layer made of Alq₃.

The green subpixel 220 includes a multi-layer stack comprised of green light-emitting units 224 alternated with charge generation layers 208 between top and bottom electrode layers 204, 206. In an embodiment, the green light-emitting unit 224 can exemplary include a α-NPD layer as hole transporting layer and an Alq₃ layer acting as electron transporting layer.

The blue subpixel 230 includes a multi-layer stack comprised of blue light-emitting units 234 alternated with charge generation layers 208 between top and bottom electrode layers 204, 206. The blue light-emitting unit 234 can include a hole transporting layer made of α-NPD, a blue emissive layer made of bis-(8-hydroxy)quinaldine aluminum phenoxide (Alq₂ OPh) and an electron transporting layer made of Alq₃.

The electrode layer 206 can be made of a transparent conductive material such as indium tin oxide, indium zinc oxide or the like, while the electrode layer 204 can be made of a conductive metal or metallic alloy such as aluminum, an alloy of aluminum and manganese, or the like. In an example of implementation, the electrode layer 204 can have a thickness of about 1500 Å to 4000 Å, while the electrode layer 206 can have a thickness of about 1000 Å.

In operation, the application of a voltage bias between the top and bottom electrodes 204, 206 produces a flow of electric current from the top electrode 204 towards the bottom electrode 206. As a result, the light-emitting unit 214, 224, 234 of each color subpixel 210, 220, 230 are stimulated to emit different color lights.

FIG. 2B is a graph depicting the degradation of color brightness obtained for an electroluminescent display according to an embodiment of the invention. As shown, the brightness degradation of the red, green and blue colors are uniform and close to one another. The multicolor display therefore does not experience adverse color intensity bias as encountered in the multicolor electroluminescent displays know in the prior art. Further, it can be observed that the slope of the degradation curve is less steep than that of the prior art, which results in a longer service life of the electroluminescent display.

FIG. 2C is a schematic view of the multi-layer structure implemented in a multicolor electroluminescent display according to a variant embodiment of the invention. The stack of each color subpixel 210, 220, 230, including one or more light-emitting unit 214, 224, 234, occupies a surface area S1, S2, S3 over the substrate 202. The surface areas S1, S2, S3 can vary according to the different aging rates, i.e. the faster the aging rate of the light-emitting unit, the larger the surface area S of the multi-layer structure.

FIG. 2D illustrates another variant embodiment in which each stack of color subpixel 210, 220, 230 can include a single light-emitting unit 214, 224, 234, respectively. The light-emitting unit 214, 224, 234 is respectively stacked between top and bottom electrode layers 204, 206. An optional charge generation layer 208 can be interposed between the light-emitting unit 214, 224, 234 and the top electrode layer 204. The surface area S1, S2, S3 increases from red 210, green 220 to blue subpixel 230, according to the increasing speed of aging rate to compensate the brightness degradation.

Realizations in accordance with the present invention have been described in the context of particular embodiments. These embodiments are meant to be illustrative and not limiting. Many variations, modifications, additions, and improvements are possible to implement the inventive features described herein. Accordingly, plural instances may be provided for components described herein as a single instance. Additionally, structures and functionality presented as discrete components in the exemplary configurations may be implemented as a combined structure or component. These and other variations, modifications, additions, and improvements may fall within the scope of the invention as defined in the claims that follow.

1. A multicolor electroluminescent display, comprising:
a pixel area defined on a substrate; and
a plurality of color light-emitting units including electroluminescent materials configured to irradiate color lights, the color light-emitting units being arranged in multi-layer stacks of specific color emissions in the pixel area of the substrate;
wherein at least two stacks of two color emissions include different numbers of color light-emitting units.

2. The multicolor electroluminescent display according to claim 1, wherein the color light-emitting units are configured to emit red, green and blue colors.

3. The multicolor electroluminescent display according to claim 2, wherein the number of stacked blue light-emitting units is greater than the number of stacked green light-emitting units.

4. The multicolor electroluminescent display according to claim 2, wherein the number of stacked green light-emitting units is greater than the number of stacked red light-emitting units.

5. The multicolor electroluminescent display according to claim 1, wherein the number of color light-emitting units in a first stack is greater than the number of color light-emitting units in a second stack if the specific color emission of one color light-emitting unit degrades faster in the first stack than in the second stack.

6. The multicolor electroluminescent display according to claim 1, wherein one stack of a specific color emission includes color light-emitting units alternated with one or more charge generation layer between a top electrode and a bottom electrode.

7. The multicolor electroluminescent display according to claim 6, wherein one of the top or bottom electrode is made of a transparent conductive material, while the other of the top or bottom electrode is made of a conductive metallic material.

8. The multicolor electroluminescent display according to claim 1, wherein at least two multi-layer stacks of two specific color emissions occupy surface areas of different size on the substrate.

9. The multicolor electroluminescent display according to claim 8, wherein the area occupied by a first stack on the substrate is greater than the area occupied by a second stack on the substrate if the specific color emission of one color light-emitting unit degrades faster in the first stack than in the second stack.

10. The multicolor electroluminescent display according to claim 1, wherein the substrate is made of a transparent material including sapphire, glass, SiC or the like.

11. The multicolor electroluminescent display according to claim 1, wherein the color light-emitting units include layers made of an organic electroluminescent material.

12. A multicolor electroluminescent display, comprising:
a pixel area defined on a substrate; and
a plurality of color light-emitting units respectively including electroluminescent materials configured to irradiate color lights, the color light-emitting units being arranged in multi-layer stacks of specific color emissions in the pixel area of the substrate;
wherein the respective sizes of at least two stacks of two specific color emissions differ from each other so as to compensate a difference in the degradation of color emission in the two stacks.

13. The multicolor electroluminescent display according to claim 12, wherein at least two stacks of two specific color emissions include different numbers of color light-emitting units.

14. The multicolor electroluminescent display according to claim 12, wherein at least two multi-layer stacks of two specific color emissions occupy surface areas of different size on the substrate.

15. The multicolor electroluminescent display according to claim 12, wherein the size of a first stack of color light-emitting units is greater than the size of a second stack of color light-emitting units if the color emission of one color light-emitting unit degrades faster in the first stack than in the second stack.

16. The multicolor electroluminescent display according to claim 12, wherein the color light-emitting units are configured to emit red, green and blue color.

17. The multicolor electroluminescent display according to claim 12, wherein one stack of a specific color emission includes color light-emitting units alternated with one or more charge generation layer between a top electrode and a bottom electrode.

18. The multicolor electroluminescent display according to claim 17, wherein one of the top or bottom electrode is made of a transparent conductive material, while the other of the top or bottom electrode is made of a conductive metallic material.

19. The multicolor electroluminescent display according to claim 12, wherein the substrate is made of a transparent material including sapphire, glass, SiC or the like.
